(19) United States
(12) Patent Application Publication
(10) Pub. No.: US 2003/0225962 A1
(43) Pub. Date: Dec. 4, 2003

(54) Memory card and memory card system

(75) Inventor: Seisuke Hirosawa, Kodaira (JP)

Correspondence Address: Miles & Stockbridge P.C., Suite 500, 1751 Pinnacle Drive, McLean, VA, 22102-3833, US

(73) Assignees: Hitachi, Ltd.; Hitachi ULSI Systems Co., Ltd.

(21) Appl. No.: 10/435,594

(22) Filed: May 12, 2003

(30) Foreign Application Priority Data
May 31, 2002 (JP) 2002-158384

(51) Int. Cl. G06F 12/00

(52) U.S. Cl. 711/103

(57) ABSTRACT

The present invention provides a memory card realizing a simplified erasing process and shortened process time as a whole and capable of preventing an illegal access to the memory card discarded, and a system using the memory card. A system includes a flash memory card and a host device which is electrically connected to the flash memory card and controls the operation of the flash memory card. The system includes an erase command for executing an operation of erasing information in a data area in a flash memory and, in addition, a purge command for executing an operation of erasing all of information in the data area and a management information area in the flash memory. The purge command is issued by the host device to the flash memory card, thereby enabling the whole areas in the flash memory to be erased by the single issue of the purge command without issuing the erase command a plurality of times.

### BACKGROUND OF THE INVENTION

The present invention relates to a memory card and, more particularly, to a technique effective to be applied to a flash memory card on which a memory such as a flash memory (flash EEPROM) is mounted and to a system using the flash memory card.

The inventors herein studied and found that there is the following technique regarding a flash memory card.

The flash memory card includes, for example, a flash memory having a data area for storing data and a controller for controlling operations of writing, reading, and erasing data to/from the data area in the flash memory. The flash memory, controller, and the like are mounted on a mounting board and the resultant is housed in a case or the like.

In the flash memory card constructed in such a manner, for example, in a data erasing process as an example studied by the inventors, a technique capable of designating 256 sectors at the maximum and erasing data in the flash memory by a single command issued by an external host device or the like is employed. According to the technique, only 256 sectors can be designated at the maximum by a single command issue. To erase the whole data area in the flash memory, the host device issues an erase command a plurality of times in accordance with capacity.

### SUMMARY OF THE INVENTION

The inventors herein has studied the flash memory card as described above and, as a result, the following became clear.

For example, to erase the whole data area in the flash memory card, the host device has to issue the erase command “all of data sectors÷256” times at the maximum. Consequently, it causes a problem such that it takes time to complete the process of erasing all of data due to an overhead of issue of a number of erase commands by the host device and increase in the number of processing times.

In a recording medium such as a flash memory card, when information in only the data area is erased, the information is not completely erased. A problem arises such that stored information in a flash memory card erased and then discarded is illegally accessed by a person who got the flash memory card. A countermeasure against the problem is requested.

The inventors herein found out that management information used to manage data stored in the data area has to be also erased in order to prevent an illegal access on precondition that a flash memory card is to be discarded while considering simplification of an erasing process and shortening of processing time, and reached a method of erasing all of information in the data area and the management information area.

The inventors herein further studied a flash memory card in which a 1-chip microcomputer for an IC card is mounted in a package. By mounting a 1-chip microcomputer for an IC card used for financial settlement or the like on a flash memory card and mounting the flash memory card on, for example, a portable device such as a portable telephone, data which has to be continuously stored even after the power supply is stopped can be stored into a flash memory and financial settlement can be performed by the portable device by using the mounted 1-chip microcomputer for the IC card.

In such a flash memory card, financial settlement information and information such as a cipher key used for communication with a host is stored in a nonvolatile memory such as an EEPROM mounted on the 1-chip microcomputer for an IC card. The information may be stored in the flash memory. In the case where the flash memory card is discarded and a person who obtains the discarded flash memory card illegally accesses the financial settlement information, personal information is leaked and a financial damage may be caused.

The information is usually stored not in the normal data area but in an access regulated area so as not to be easily accessed.

With respect to such a flash memory card as well, to improve reliability of the flash memory card by preventing an illegal access to the flash memory and the EEPROM mounted on the microcomputer for an IC card, the inventors herein found out necessity of erasing not only information in the data area but also data in the access regulating area and management information for managing the data stored in the access regulating area, and reached a method of erasing all of information in the data area, access regulated area, and management information area.

An object of the invention is to provide a memory card realizing a simplified erasing process and shorter process time as a whole by newly generating a command for easing all of information in a data area and a management information area, and a system using the memory card.

Another object of the invention is to provide a memory card capable of preventing an illegal access to a discarded memory card and a system using the memory card.

Further another object of the invention is to provide a nonvolatile memory card having the function of financial settlement or the like of an IC card and capable of preventing an illegal access to financial settlement information or the like in the memory card discarded, and a system using the memory card.

The above and other objects and novel features of the invention will become apparent from the description of the specification and appended drawings.

Outline of representative ones of inventions disclosed in the specification will be described as follows.

The invention is applied to a memory card including: a memory having a data area for storing data and a management information area for storing information of managing data stored in the data area; and a controller for controlling an operation to each of the areas in the memory by a command supplied from the outside, and has the following characteristics.

(1) The command is a command for executing an operation of erasing all of information in the data area and the management information area in the memory. Further, the controller has a function of repeatedly executing an operation of erasing information in the data area and the management information area in the memory on a predetermined block unit basis when the command is received once. Particularly, as the memory, a flash memory or the like is applied. With the configuration, information in all of areas in a memory such as a flash memory can be erased by single input of the command from the outside. Thus, the erasing process can be simplified and the entire process time can be shortened.

(2) The command includes a first command for executing an operation of shifting an operation state from a normal state to an erasing process pre-execution state, and a second command of performing an operation of shifting the operation state from the erasing process pre-execution state to an erasing process execution state and erasing all of information in the data area and the management information area in the memory. Further, the controller has a function of repeatedly executing an operation of erasing information in the data area and the management information area in the memory on a predetermined block unit basis when the first and second commands are successively received. Particularly, as the memory, a flash memory or the like is applied. With the configuration, only when the first and second commands are successively input from the outside, information in all of the areas in the memory such as a flash memory can be erased. Thus, the erasing process can be prevented from being easily executed.

The invention is also applied to a system having the memory card and a host device or the like for controlling the operation of the memory card by supplying a command to the memory card and has the following characteristics.

(3) The command includes a third command for executing an operation of erasing information in the data area in the memory and a fourth command of executing an operation of erasing all of information in the data area and the management information area in the memory. Further, the fourth command includes a first command of shifting the operation state from a normal state to an erasing process pre-execution state, and a second command of executing an operation of shifting the operation state from the erasing process pre-execution state to an erasing process execution state and erasing all of information in the data area and the management information area in the memory. Particularly, as the memory, a flash memory or the like is applied. With the configuration, a process similar to that in (1) can be executed by inputting the single fourth command from the host device. By inputting the first and second commands successively, a process similar to that in (2) can be executed. As a result, the invention can deal with the case where the memory card is discarded (cannot be re-used). In the case of re-using the memory card without being discarded, it is sufficient to erase only the information in the data area in the memory by inputting the third command.

The invention is applied to a memory card having a function of performing financial settlement or the like of an IC card and including: a memory having a data area for storing data, a management information area for storing information for managing the data stored in the data area, an access regulating area for storing financial settlement information or the like, to which a normal access of the memory card is regulated, and a management information area for storing information for managing the data stored in the access regulating area; and a controller for controlling operation on each of the areas in the memory by a command supplied from the outside. A microcomputer function for performing financial settlement of the IC card is provided on a semiconductor substrate on which the controller is mounted or on another semiconductor substrate. The controller performs a control also on the microcomputer function. The invention has the following characteristics.

(4) The command includes a first command for executing an operation of shifting an operation state from a normal state to an erasing process pre-execution state, a fifth command of performing an operation of erasing information stored in a data area in a memory and a management area for managing the data stored in the data area, and a sixth command for executing an operation of erasing information stored in an access regulating area in the memory, a management area for managing the data stored in the access regulating area, and a data area in a nonvolatile memory such as an EEPROM formed on the same semiconductor substrate on which the microcomputer function is provided. Further, the controller has a function of repeatedly executing an operation of erasing information in the data area and the management information area for the data area in the memory on a predetermined block unit basis when the first and fifth commands are successively received. The controller has a function of repeatedly executing an operation of erasing information in the access regulating area in the memory, the management information area for the access regulating area, and the data area in the nonvolatile memory such as an EEPROM on a predetermined block unit basis when the sixth command is input subsequent to the first command or the fifth command subsequent to the first command. With the configuration, when the fifth command is input subsequent from the first command from the outside, information in all of the data areas in the memory can be erased. In the case where the sixth command is input subsequent to the first command or the fifth command subsequent to the first command, financial settlement information or the like stored in the access regulating area and the data area in the nonvolatile memory such as the EEPROM can be erased. Either the memory card function or the financial settlement function is disabled or both of the functions can be disabled.

The invention is also applied to a system having the memory card and a host device or the like for controlling the operation of the memory card by supplying a command to the memory card and has the following characteristics.

(5) The command includes a fifth command for executing an operation of erasing information in the data area in the memory and the management information area for the data area, and a sixth command of executing an operation of erasing information stored in the access regulating area in the memory, the management information area for the access regulating area, and the data area in the nonvolatile memory such as an EEPROM. By inputting either the fifth or sixth command subsequent to the first command from the host device, either the memory card function or the financial settlement function is disabled. By inputting both commands, both of the functions can be disabled. As a result, when the host device detects an illegal access to the financial settlement function, only the financial settlement function is disabled so that the illegal access can be prevented from being made again or increased. In the case where financial settlement information is provided according to a plurality of applications, by erasing the financial settlement information according to a specific application, the specific application can be prevented from being erroneously used.

### BRIEF DESCRIPTION OF THE DRAWINGS

FIG. 1 is a configuration diagram showing a system using a memory card of an embodiment of the invention.

FIG. 2 is a configuration diagram showing a flash memory in a flash memory card in the system of the embodiment of the invention.

FIG. 3 is a configuration diagram showing a management information area in the flash memory in the system of the embodiment of the invention.

FIG. 4 is an explanatory diagram showing a processing flow of an erase command and a purge command in the system of the embodiment of the invention while being compared with each other.

FIG. 5 is a flowchart showing processes performed in response to the erase command in the system of the embodiment of the invention.

FIG. 6 is a flowchart showing processes performed in response to the purge command in the system of the embodiment of the invention.

FIG. 7 is an explanatory diagram showing a state transition by the purge command in the system of the embodiment of the invention.

FIGS. 8A and 8B are explanatory diagrams showing the purge command in the system of the embodiment of the invention.

FIG. 9 is a configuration diagram showing a system using a memory card of the embodiment of the invention.

FIG. 10 is a configuration diagram showing a system using a memory card of the embodiment of the invention.

FIG. 11 is a timing chart showing processes performed in response to the purge command in the system of the embodiment of the invention.

FIG. 12 is an explanatory diagram showing a state transition by the purge command in the system of the embodiment of the invention.

FIG. 13 is an explanatory diagram showing operations of the purge command in the system of the embodiment of the invention.

FIG. 14 is an explanatory diagram showing operations of the purge command in the system of the embodiment of the invention.

FIG. 15 is an explanatory diagram showing operations of the purge command in the system of the embodiment of the invention.

FIG. 16 is a flowchart showing a resetting process of an IC card microcomputer in the system of the embodiment of the invention.

### DETAILED DESCRIPTION OF THE PREFERRED EMBODIMENTS

An embodiment of the invention will be described in detail hereinbelow with reference to the drawings.

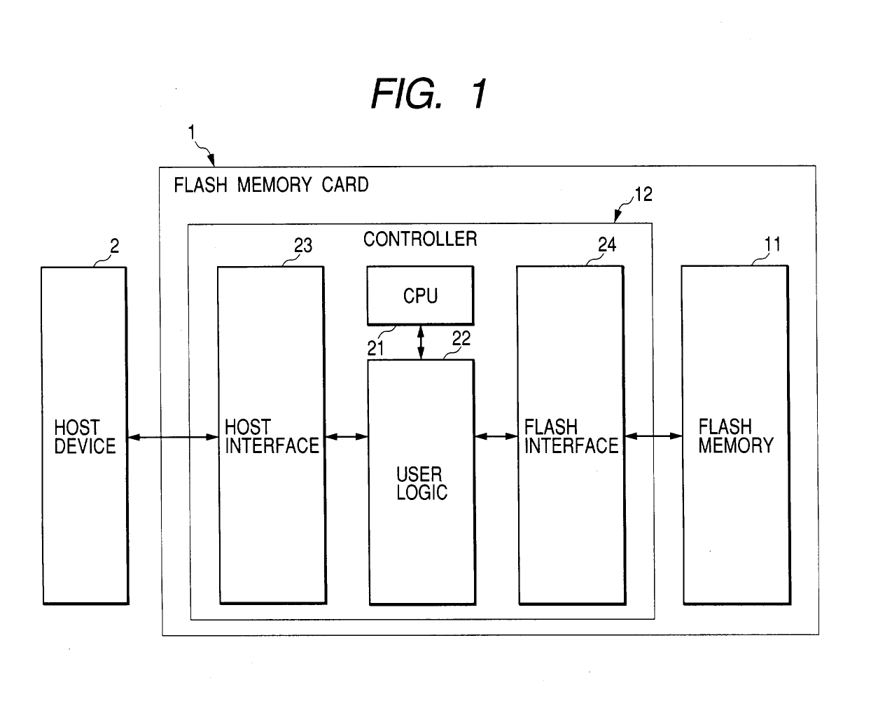

With reference to FIG. 1, an example of the configuration of a system using a memory card of an embodiment of the invention will be described. FIG. 1 is a configuration diagram of the system using the memory card of the embodiment.

The system of the embodiment is a system using a flash memory card as an example of the memory card and is constructed by a flash memory card 1 and a host device 2 which is electrically connected to the flash memory card 1 and controls operation of the flash memory card 1 by supplying a command to the flash memory card 1.

The flash memory card 1 includes a flash memory 11 for storing various information and a controller 12 for controlling operation on the flash memory 11. Particularly, to the flash memory card 1, not only a command (called an erase command) for executing an operation of erasing information in a data area in the flash memory 11 but also a command (called a purge command) for executing an operation of erasing all of information in the data area and a management information area in the flash memory 11 are generated from the host device 2.

The controller 12 includes: a CPU 21 for controlling a computing process of the whole card; a user logic 22 having a function of controlling a signal connected to the host device 2 and a register to which the host device 2 accesses, a control function of ECC generation and error detection/correction, a data buffer, a register, and the like; a host interface 23 as an interface with the host device 2; and a flash interface 24 as an interface with the flash memory 11.

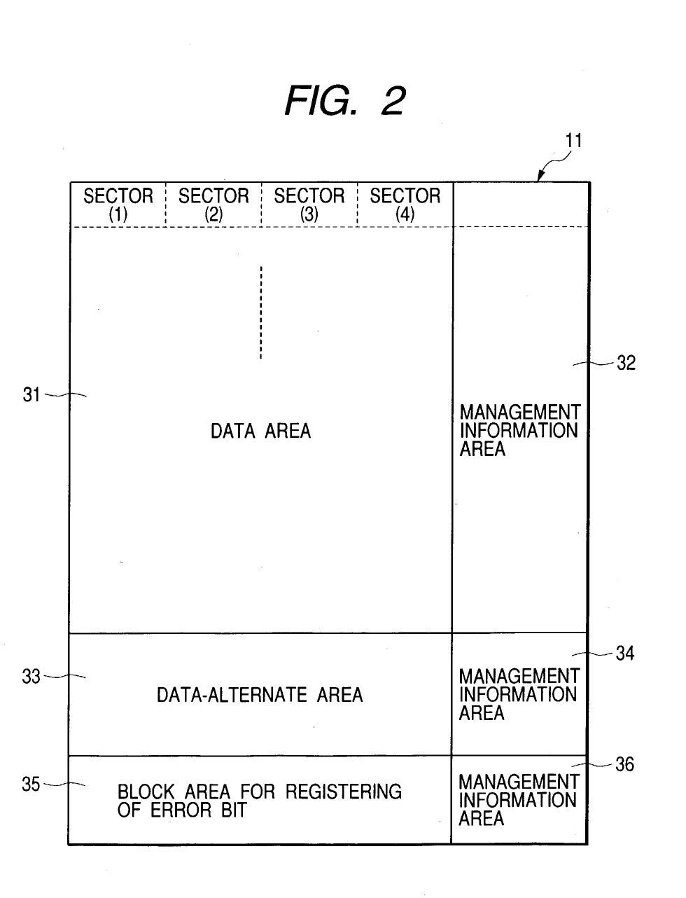

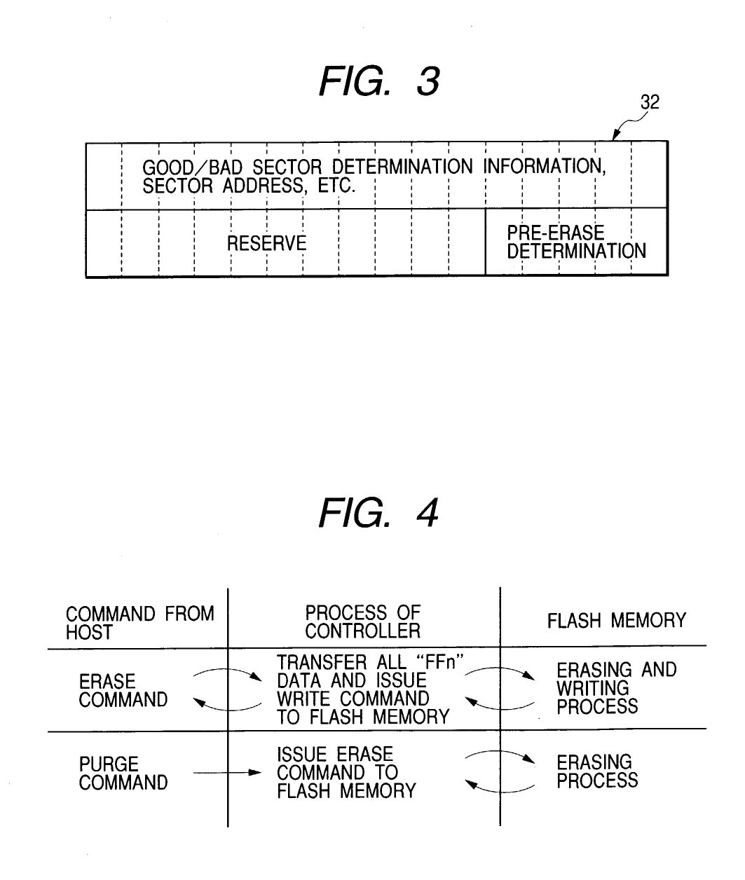

An example of the configuration of the flash memory in the flash memory card in the system of the embodiment will now be described with reference to FIGS. 2 and 3. FIG. 2 is a configuration diagram of the flash memory in the flash memory card. FIG. 3 is a configuration diagram of a management information area in the flash memory.

The flash memory 11 includes, for example, as shown in FIG. 2, a data area 31 for storing data and a management information area 32 for storing information for managing the data stored in the data area 31. For example, although not limited, in an AND type memory cell array configuration of 256 Mbits, 2080 bytes are assigned to the data area 31 and 32 bytes are assigned to the management information area 32 per word line. 2080 bytes of the data area 31 corresponds to four sectors. In one sector, data of 512 bytes and an 8-byte ECC code are stored.

The flash memory 11 includes, in addition to the data area 31 and the management information area 32, a data-alternate area 33 for replacing an error bit in the data area 31, a management information area 34 for managing information in the data-alternate area 33, an error-bit development registering block area 35 for registering development of an error bit, and a management information area 36 for managing the information in the error-bit development registering block area 35.

In the management information area 32 for the data area 31, as shown in FIG. 3 for example, data good/bad determination information, sector address information, determination information indicative of whether information can be pre-erased or not, and the like is stored. For example, in the case where the pre-erase determination information is “00h”, it expresses that data is stored in a corresponding sector and the sector is in use. In the case of erasing the data in the sector, by writing “FFh”, an erased state can be determined.

An example of the processing flow of the erase command and the purge command in the system of the embodiment will be described by comparison with reference to FIG. 4. FIG. 4 is an explanatory diagram of the processing flow of the erase command and the purge command by comparison.

In the case of the process performed in response to the erase command, the erase command is issued from the host device 2 to the flash memory card 1. In the flash memory card 1 which receives the erase command, the controller 12 transfers, for example, all “FFh” data to the flash memory 11 and further generates a write command. By the write command, a writing process is performed in the flash memory 11.

In the case of performing the writing process in the flash memory 11, an erasing operation is performed on a predetermined block unit basis in the flash memory 11 and, after that, data “FFh” to be written is written into a memory cell. Since data indicative of the threshold voltage after the erasing operation of the flash memory is “FFh” in this case, “FFh” is transferred as data to be written to the flash memory. It is sufficient to transfer, as write data, the same data as data indicated by the threshold voltage after the erasing operation to the flash memory.

In the case of generating the erase command for erasing data on a predetermined block unit basis in the flash memory 11, in place of generating the write command after transferring the data “FFh”, the erase command may be issued. In this case, the information of the block is read before issue of the erase command. After issuing the erase command, management information and the like is written again.

In the case of the process performed in response to the erase command, the process is repeated on a predetermined block unit basis. After completion of the process on the block, to sequentially perform the process on the next block, in a manner similar to the above, the erase command is repeatedly issued from the host device 2 to the flash memory card 1. By transferring All “FFh” data from the controller 12 to the flash memory 11 and generating the write command, the writing process of the flash memory 11 is sequentially executed on the block unit basis.

In the case of the process performed in response to the purge command, the purge command is generated only once from the host device 2 to the flash memory card 1. On receipt of the purge command, in the flash memory card 1, the controller 12 issues the erase command to the flash memory 11. To repeat the process on the predetermined block unit basis and, after completion of the process on a block, to sequentially perform the process on the next block, in a manner similar to the above, the controller 12 repeatedly issues the erase command. In the flash memory 11, consequently, by the repetitive issue of the erase command between the controller 12 and the flash memory 11, the writing process on the flash memory 11 is sequentially executed on the block unit basis.

As described above, when the process performed in response to the erase command and the process performed in response to the purge command are compared with each other, in the erase command process, the erase command is repeated generated from the host device 2 to the flash memory card 1. In contrast, in the purge command process, the process can be performed by a single purge command generated from the host device 2 to the flash memory card 1.

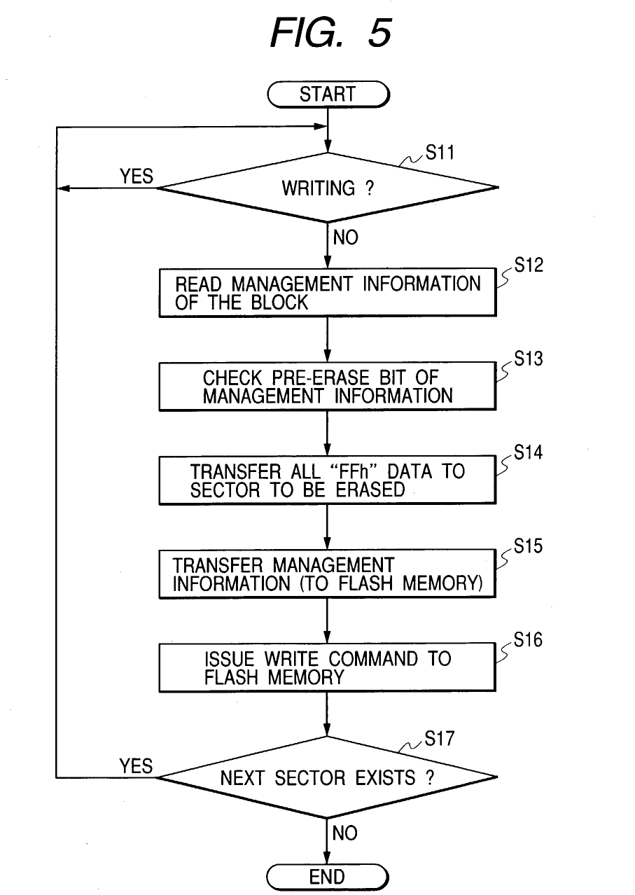

An example of the flow of processes performed in response to the erase command will be described in detail with reference to FIG. 5. FIG. 5 is a flowchart of the processes performed in response to the erase command.

First, after the process is started by issue of the erase command, whether a writing operation is being performed or not is determined (step S11). When the writing operation is not being performed (NO), management information (data good/bad determination information, address information of a sector, and the like) in the block of the management information area 32 is read (step S12). On the other hand, if the writing operation is being performed (YES), after completion of the writing operation, the management information of the block is read. After that, a pre-erase determination bit in the management information area 32 is checked (step S13).

When it is found as a result of the check that the data of the block is not in use but can be pre-erased, all “FFh” data is transferred to the sector to be erased in the flash memory 11 (step S14), and the management information is transferred (step S15). After that, a write command is issued to the flash memory 11 (step S16). In such a manner, the writing process on the sector to be erased in the flash memory 11 is performed.

Subsequently, whether there is the next sector or not is determined (step S17). If there is the next sector (YES), the processes from step S11 are repeated. If there is no next sector (NO), the routine is finished.

In the process performed in response to the erase command, only the information in the data area 31 in the flash memory 11 is erased by the writing process, so that the flash memory card 1 can be re-used.

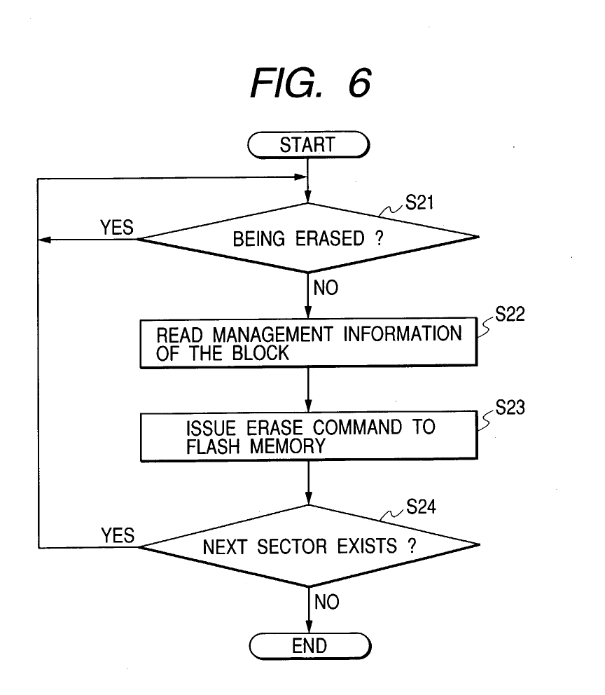

An example of the flow of process performed in response to the purge command will now be described in detail with reference to FIG. 6. FIG. 6 shows a flowchart of the process performed in response to the purge command.

First, when the process is started by issue of the purge command, whether erasing operation is being performed or not is determined (step S21). If NO, the management information in the block in the management information area 32 is read (step S22). If YES, after completion of the process, the management information of the block is read. After that, the erase command is issued to the flash memory 11 (step S23). In such a manner, the process of erasing information in the sector to be erased in the flash memory 11 is performed.

Subsequently, whether there is the next sector or not is determined (step S24). If there is the next sector (YES), the process from step S21 is repeated. If there is no next sector (NO), the routine is finished.

In the process performed in response to the purge command, all of information in the data area 31 and the management information area 32 in the flash memory 11 is erased by the erasing process. Consequently, the flash memory card 1 cannot be re-used.

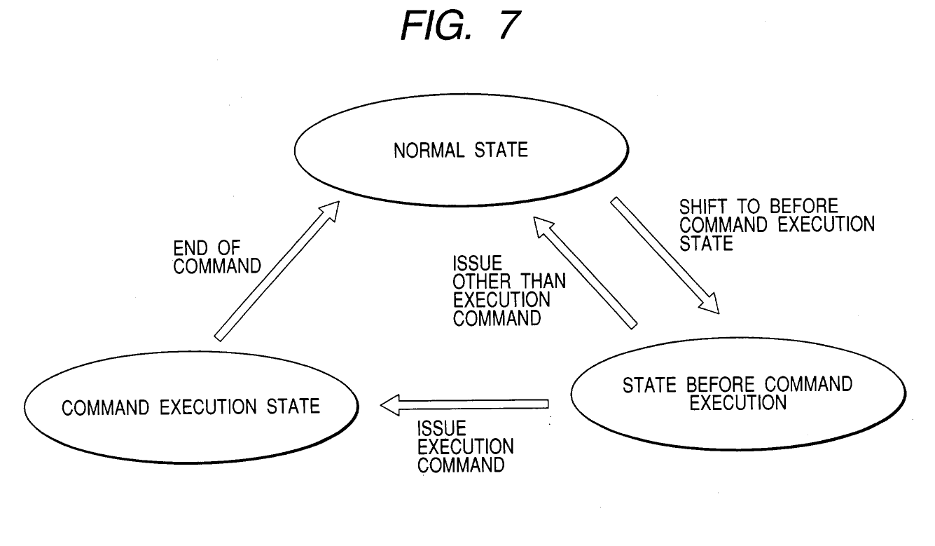

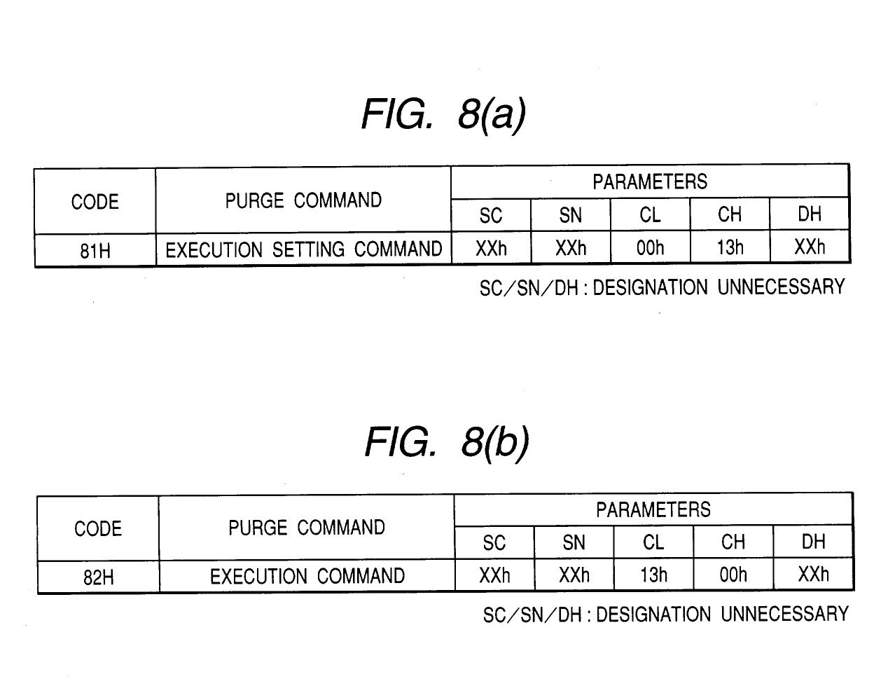

The structure of the purge command will now be described in detail with reference to FIG. 7 and FIGS. 8A and 8B. FIG. 7 is an explanatory diagram of a state transition by the purge command. FIGS. 8A and 8B are explanatory diagrams of the purge command.

The purge command has, different from a normal command, in order to prevent a command process from being easily executed, a purge command execution setting command for executing an operation of shifting an operation state from a normal state to an erasing process pre-execution state, and a purge command execution command for executing an operation of shifting the operation state from the erasing process pre-execution state to an erasing process execution state. The purge command is not executed unless the following procedure is taken. Command codes and parameters (registers SC, SN, CL, CH, and DH) are an example and the invention is not limited to them.

(1) Arbitrary values (for example, “00h” and “13h”) are set for the registers CL and CH and a purge command execution setting command (for example, command code “81h”) is issued to make an execution setting of the purge command, thereby setting the command pre-execution state. By generation of the purge command execution setting command, the operation state shifts from the normal state to the command pre-execution state.

(2) Immediately after that, in a manner similar to (1) arbitrary values (for example, “13h” and “00h”) are set for the registers CL and CH, a purge command execution command (for example, command code “82h”) is issued, and the purge command is executed. By the issue of the purge command execution command, the operation state shifts to the command execution state, and the purge command for erasing all of information in the flash memory 11 can be executed. However, in the case where a command other than the purge command execution command is issued at this time, the operation state shifts to the normal state. Even if the purge command execution command is issued after that, the purge command is not executed.

After completion of execution of the purge command in the command execution state, the operation state shifts to the normal state.

Therefore, according to the embodiment, by newly generating the purge command for performing the process of erasing information in all of areas in the flash memory 11 by issue of the command of once from the host device 2 to the flash memory card 1, without issuing the erase command a plurality of times, information in all of the areas in the flash memory 11 can be automatically erased by issue of the purge command of once. As a result, the process performed in response to the purge command can be simplified as compared with the case of the erase command, and the whole processing time of the command can be shortened.

Further, since the operation state is not shifted to the command execution state unless the purge command execution setting command is issued and, subsequently, the purge command execution command is issued, the purge command is different from a normal command, and the command process cannot be easily executed.

After issue of the erase command, the flash memory card 1 can be re-used. In contrast, since the purge command operates as a destruction command of making the flash memory card 1 unusable after execution of the command, an illegal access to the discarded flash memory card 1 can be prevented.

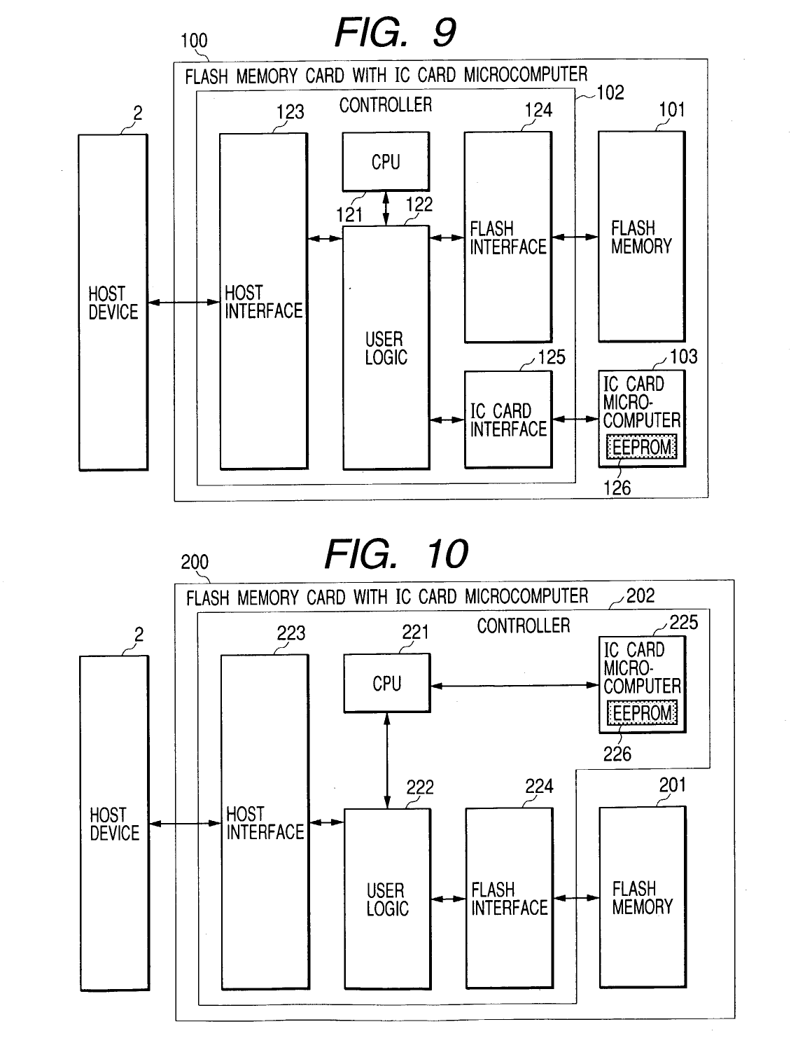

An example of the configuration of the system using a memory card of another embodiment of the invention will be described with reference to FIGS. 9 and 10. The memory card has the functions shown in FIGS. 1 to 8 as memory card functions and, in addition, a financial settlement function. Since the memory card functions are the same as those shown in FIGS. 1 to 8, the description will not be repeated.

The system using the memory card of the embodiment shown in FIG. 9 takes the form of a system using a flash memory card as an example of the memory card and includes a flash memory card 100 and the host device 2 which is electrically connected to the flash memory card 100 and controls the operation of the flash memory card 100 by supplying a command to the flash memory card 100.

The flash memory card 100 includes a flash memory 101 for storing various information, a controller 102 for controlling operation onto the flash memory 101, and an IC card microcomputer 103 for performing a financial settlement process. Particularly, to the flash memory card 101 and an EEPROM 126 mounted on the IC card microcomputer 103, the host device 2 issues a command (called a purge command) for executing an operation of erasing all of financial settlement information and the like stored in an access regulating area and a management information area for the access regulating area in the flash memory 101 and also in the EEPROM 126.

The controller 102 includes: a CPU 121 for controlling a computing process of the whole card; an IC card interface 125 as an interface with the IC card microcomputer 103; a user logic 122 having the functions of the user logic 22 in FIG. 1 and, in addition, a control function of the IC card microcomputer 103 in the case where the command from the host device 2 is related to financial settlement; a host interface 123; and a flash interface 124.

The system using the memory card of the embodiment shown in FIG. 10 takes the form of a system using a flash memory card as an example of the memory card and includes a flash memory card 200 and the host device 2 which is electrically connected to the flash memory card 200 and controls the operation of the flash memory card 200 by supplying a command to the flash memory card 200.

The flash memory card 200 of FIG. 10 includes: a controller 202 in which the controller 102 and the IC card microcomputer 103, which are formed in a different semiconductor substrate in the flash memory card 100 in FIG. 9, are formed on the same semiconductor substrate; and a flash memory 201 for storing various information.

In the controller 102 in FIG. 9, the IC card microcomputer 103 is connected to the user logic 122 via the IC card interface 125. On the other hand, in the controller 202 in FIG. 10, an IC card microcomputer 225 is connected to a CPU 221. Since the IC card interface 125 is provided in FIG. 9, the IC card microcomputer 103 is connected to the user logic 122. In FIG. 10 as well, the IC card microcomputer 225 may be connected to a user logic 222. On the contrary, in FIG. 9, the CPU 121 and the IC card interface 125 may be connected to each other.

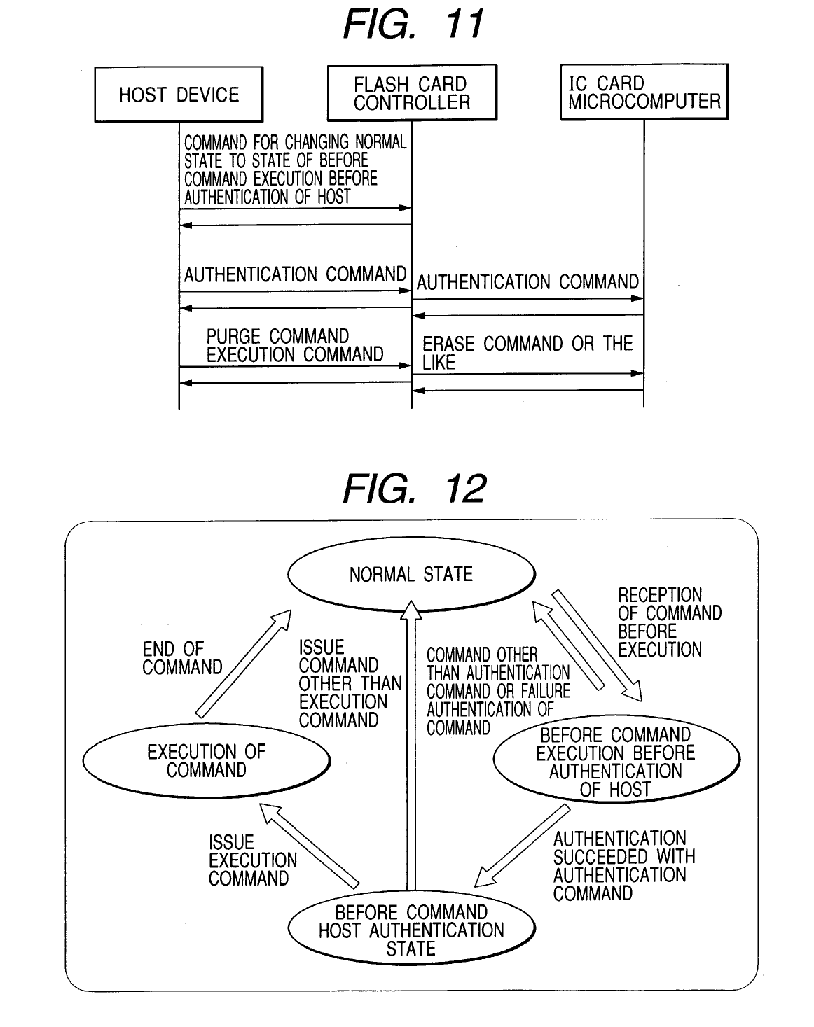

The structure of the purge command will be described in detail with reference to FIGS. 11 and 12. FIG. 11 is a timing chart with respect to the purge command, and FIG. 12 is an explanatory diagram of a state transition with respect to the purge command.

The purge command has, different from a normal command, in order to prevent a command process from being easily executed, a purge command execution setting command for executing an operation of shifting an operation state from a normal state to an erasing process pre-execution state, an authentication command for determining whether execution of the command is authenticated or not, and a purge command execution command for shifting the erasing process pre-execution state to an erasing process execution state. The purge command is not executed unless the following procedure is taken. Command codes and parameters are an example and, obviously, the invention is not limited to them.

(1) The execution setting command is issued in a manner similar to the purge command.

(2) Immediately after that, subsequent to (1), information for authenticating that an access is a proper access, such as a PIN is set for the registers CL and CH and an authentication command is issued, thereby performing authentication. If authentication fails, the operation state shifts to the normal state. Even when the purge command execution command is issued after that, the purge command is not executed. Although not limited, irrespective of whether authentication has succeeded or not, the same response may be issued to the host device 2. In this way, even when an illegal access to illegally obtain authentication information such as PIN succeeds in the authentication, the fact cannot be known from the authentication command. Thus, it can contribute to improve the reliability of the flash memory card.

(3) Immediately after success in the authentication, subsequent to (2), arbitrary values are set in the registers CL and CH, and the purge command execution command is issued to execute the purge command.

However, in the case where a command other than the purge command execution command is issued at this time, the operation state shifts to the normal state. Even if the purge command execution command is issued after that, the purge command is not executed.

After completion of execution of the purge command in the command execution state, the operation state shifts to the normal state.

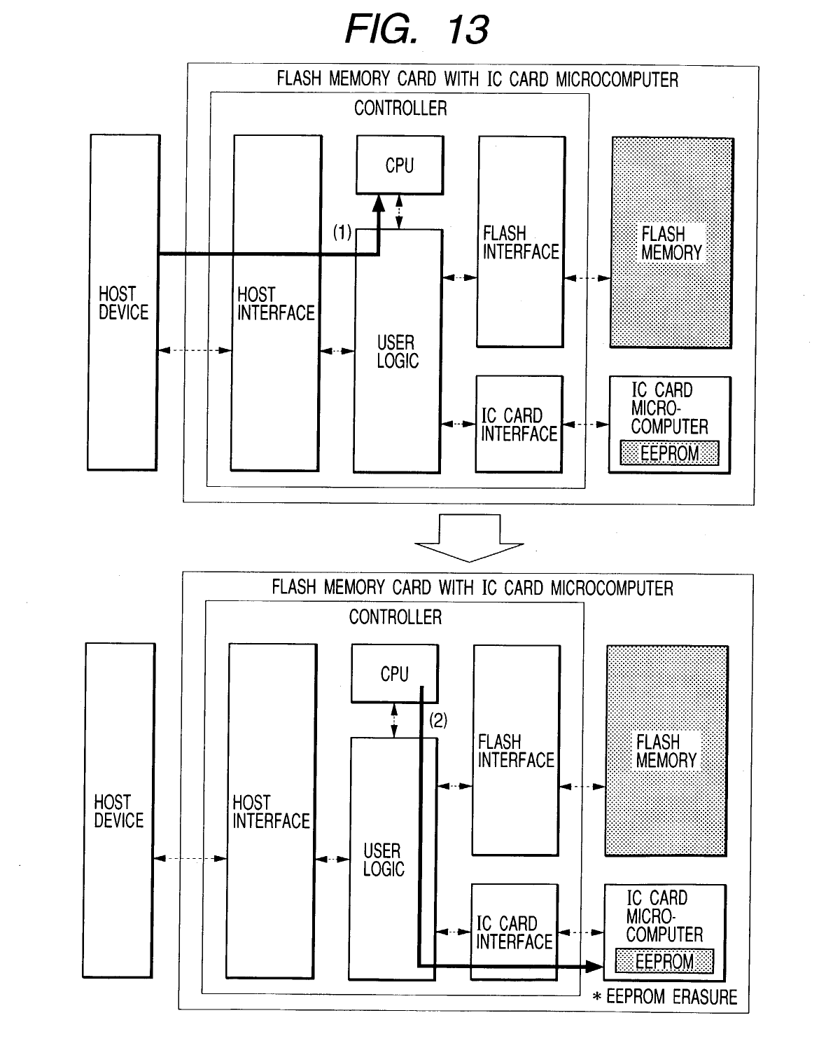

Referring to FIG. 13 and subsequent figures, concrete operation of the purge command will be described. Although description will be given on the basis of the system of FIG. 9, obviously, there will be no particular difference in the case of the system of FIG. 10. In each of the examples of FIG. 13 and subsequent figures, determination may be made according to the values set in the registers CL and CH at the time of issuing the purge command execution command. The command codes may vary.

FIG. 13 shows an example of erasing all or part of information stored in the EEPROM 126 mounted on the IC card microcomputer 103 by execution of the purge command. The CPU 121 receives the purge command execution setting command from the host device 2 and, after that, determines whether the access is a proper access or not on the basis of an authentication command issued by the host device 2. In the case where the access is authenticated as a proper access, the host device 2 erases all of the information stored in the EEPROM 126 in response to the purge command execution command. The erasing operation is performed by controlling the CPU and the controller included in the IC card microcomputer so as to sequentially perform the erasing operation. Alternately, the erasing operation is performed when the CPU 121 directly executes the operation of erasing the information of the EEPROM 126.

By erasing all of information such as financial settlement information, cipher key, or the like stored in the EEPROM 126, the financial settlement function of the flash memory card is disabled to be re-used. In the case where information according to a plurality of applications is stored in the EEPROM 126 and, for example, the single flash memory card 100 has the financial settlement function of different financial institutes, if a contract with one of the financial institutes is canceled, only the financial settlement function regarding the application cannot be re-used.

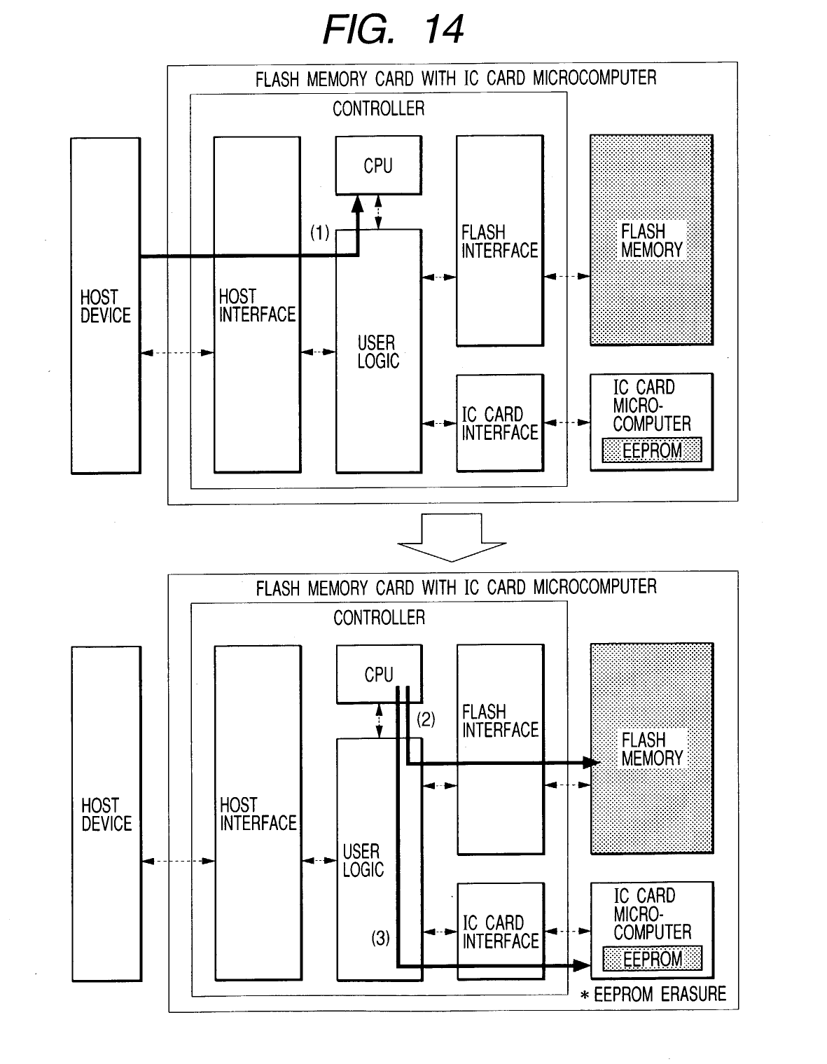

FIG. 14 shows an example of erasing part or all of information stored in the EEPROM 126 mounted on the IC card microcomputer 103 and erasing part or all of information stored in the flash memory 101 by executing the purge command.

By erasing all of information stored in the EEPROM 126 and all of information stored in the flash memory 101, both the memory card function and the financial settlement function of the flash memory card are disabled to be re-used.

In the case where information according to a plurality of applications is stored in the EEPROM 126 and additional information is stored according to each of the applications in the flash memory 101, by erasing all of the information stored in the EEPROM 126 and all of the additional information stored in the flash memory 101, the financial settlement function of the flash memory card is disable to be re-used.

Further, by erasing information according to a part of the applications from the EEPROM 126 and the additional information according to the part of the applications from the flash memory 101, only the financial settlement function regarding the application is disabled to be re-used.

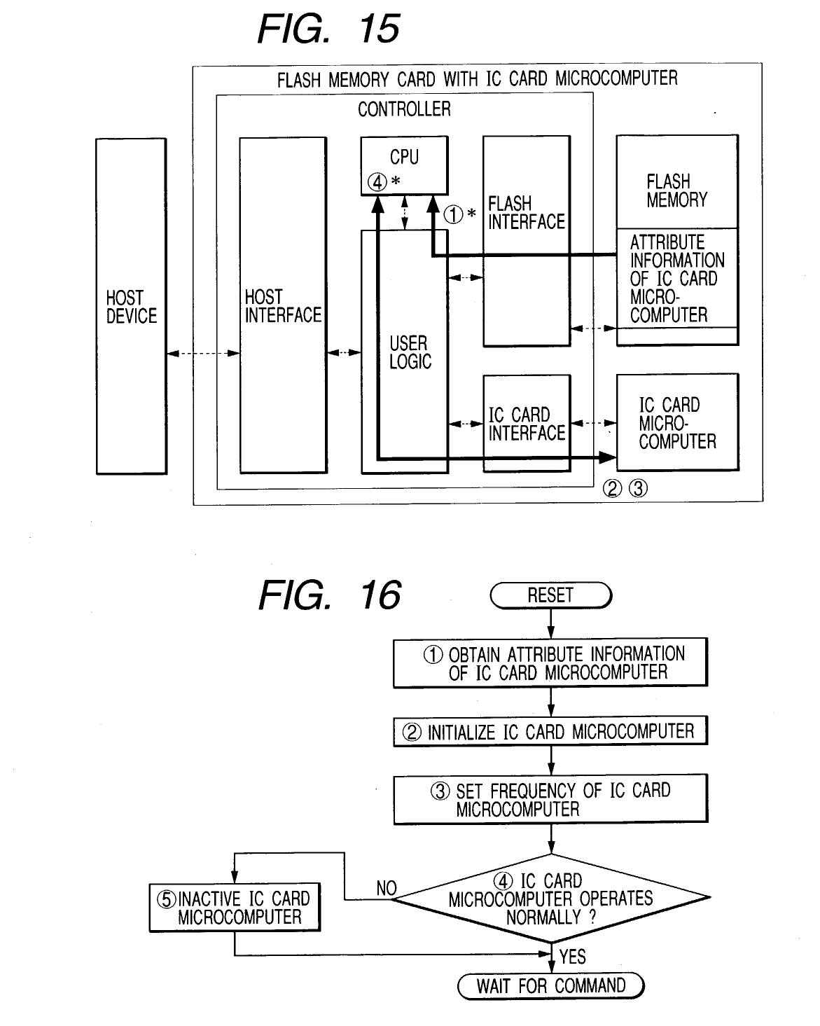

FIG. 15 shows an example of easing all or part of information stored in the flash memory 101 by executing the purge command. The attribute information of the IC card microcomputer such as a transfer method and a transfer rate may be stored in the flash memory 101 or EEPROM 126. In the case of using the financial settlement function of the IC card microcomputer, the IC card microcomputer performs communication with the host device 2 by using the attribute information. By erasing the information by executing the purge command, the host device 2 becomes unable to recognize the IC card microcomputer, and the financial settlement function of the flash memory card is disabled to be re-used.

FIG. 16 shows an example of a process of resetting the IC card microcomputer. In step S31, the IC card microcomputer obtains the attribute information of the IC card microcomputer stored in the flash memory 101 or EEPROM 126. In step S32, a microcomputer initializing process is performed. In step S33, on the basis of the attribute information obtained in step S31, setting of the frequency of transfer and the like is performed. In step S34, whether the IC card microcomputer operates normally or not is determined. If YES, a command waiting state is set. In the case where the attribute information of the IC card microcomputer is erased, the frequency setting or the like cannot be performed in step S33. Consequently, in step S34, it is not determined that the IC card microcomputer normally operates. In step S35, the IC card microcomputer is inactivated and the external host device 2 cannot recognize the IC card microcomputer due to no response from the IC card microcomputer.

The order of the acquisition of the attribute information in step S31 and the IC card microcomputer initializing operation in step S32 may be reversed.

Although the invention has been concretely described above on the basis of its embodiments, obviously, the invention is not limited to the foregoing embodiments but can be variously modified without departing from the gist.

For example, a flash memory was taken as an example of the memory in the foregoing embodiments. The invention can be also applied to a nonvolatile memory such as an EEPROM.

The invention is effectively applied to the flash memory card as described above and can be also widely generally applied to a device such as a memory module or memory device on which a flash memory, a nonvolatile memory, or the like is mounted.

Effects obtained by representative ones of the inventions disclosed in the specification will be briefly described as follows.

(1) By generating a command for executing the operation of erasing all of information in the data area and the management information area in the memory, without generating an erase command a plurality of times, information in all of the areas in the memory can be erased by generating a single command. Thus, the erasing process can be simplified and the entire processing time can be shortened.

(2) By providing the first command for executing the operation of shifting the operation state from the normal state to the erasing process pre-execution state and the second command of executing the operation of shifting the operation state from the erasing process pre-execution state to the erasing process execution state and erasing all of information in the data area and the management information area in the memory, only in the case where the second command is input subsequent to the first command, information of all of the areas in the memory can be erased. Thus, the erasing process can be prevented from being easily executed.

(3) By erasing information in all of the areas in the memory after execution of the command, the memory card is disabled to be re-used. Thus, an illegal access to the discarded memory card can be prevented.

(4) In the flash memory card having the financial settlement function such as an IC card microcomputer, by erasing all or part of the financial settlement information stored in the EEPROM or flash memory mounted on the IC card microcomputer, all of the financial settlement function of the memory card or the financial settlement function of a specific application is disabled to be used. Thus, an illegal access to the memory card discarded can be prevented or the specific application can be prevented from being erroneously used.

(5) The host device may issue the purge command in response to an instruction of the user and, in addition, in the case where an operation suspected to have intention of an illegal access, for example, input of erroneous authentication information such as PIN is repeated. By issue of the purge command, the financial settlement function of the flash memory card can be disabled, so that an illegal access can be prevented from being continued or increased. In the case where the operation which is suspected to have intention of an illegal access is repeated, on the basis of not only an instruction from the host device but also detection of the controller of the flash memory card, the purge command may be internally issued.

What is claimed is:

1. A memory card comprising:
a memory having a data area for storing data and a management information area for storing information of managing data stored in said data area; and
a controller for controlling an operation to each of the areas in said memory by a command supplied from the outside,
wherein said command is a command for executing an operation of erasing all of information in said data area and said management information area in said memory.

2. The memory card according to claim 1, wherein said controller has a function of repeatedly executing an operation of erasing information in said data area and said management information area in said memory on a predetermined block unit basis when said command is received once.

3. The memory card according to claim 1, wherein said memory is a flash memory.

4. A memory card comprising:
a memory having a data area for storing data and a management information area for storing information of managing data stored in said data area; and
a controller for controlling an operation on each of the areas in said memory by a command supplied from the outside,
wherein said command includes a first command for executing an operation of shifting an operation state from a normal state to an erasing process pre-execution state, and a second command of performing an operation of shifting the operation state from said erasing process pre-execution state to an erasing process execution state and erasing all of information in said data area and said management information area in said memory.

5. The memory card according to claim 4, wherein said controller has a function of repeatedly executing an operation of erasing information in said data area and said management information area in said memory on a predetermined block unit basis when said first and second commands are successively received.

6. The memory card according to claim 4, wherein said memory is a flash memory.

7. A system comprising:
memory card including: a memory having a data area for storing data and a management information area for storing information of managing data stored in said data area; and a controller for controlling an operation on each of the areas in said memory by a command supplied from the outside; and
a host device for controlling operation of said memory card by supplying a command to said memory card,
wherein said command includes a third command for executing an operation of erasing information in said data area in said memory and a fourth command of executing an operation of erasing all of information in said data area and said management information area in said memory.

8. The system according to claim 7, wherein said fourth command includes a first command of shifting the operation state from a normal state to an erasing process pre-execution state, and a second command of executing an operation of shifting the operation state from said erasing process pre-execution state to an erasing process execution state and erasing all of information in said data area and said management information area in said memory.

9. The system according to claim 7, wherein said memory is a flash memory.

10. A semiconductor processor comprising:
a controller;
an encryption processor; and
a first nonvolatile memory having a plurality of nonvolatile memory cells and storing encrypted information,
wherein said controller sets each of the nonvolatile memory cells in said first nonvolatile memory into a first state in response to a first command from the outside.

11. The semiconductor processor according to claim 10,
wherein said controller can be connected to a second nonvolatile memory,
wherein said second nonvolatile memory has a plurality of word lines to each of which a plurality of nonvolatile memory cells included in a first area and a second area are connected, and
wherein said controller sequentially selects a plurality of word lines of said second nonvolatile memory and setting the plurality of nonvolatile memory cells included in said first and second areas into the first state in response to a second command from the outside.

12. The semiconductor processor according to claim 11,
wherein said encryption processor and said first nonvolatile memory are formed on one semiconductor substrate,
wherein said controller is formed on another semiconductor substrate, and
wherein said second nonvolatile memory is formed on further another semiconductor substrate.

13. A nonvolatile memory device comprising:
a first semiconductor processor;
a second semiconductor processor; and
a first nonvolatile memory connected to said first semiconductor processor,
wherein said second semiconductor processor has a second nonvolatile memory,
a plurality of commands are input from the outside to said first semiconductor processor,
said first semiconductor processor performs a control of erasing all of information stored in said first nonvolatile memory in response to input of a first command, and
said first semiconductor processor performs a control of erasing all of information stored in said second nonvolatile memory in response to input of a second command.

14. The nonvolatile memory device according to claim 13,
wherein said first command includes a first process command and a second process command,
wherein said first semiconductor processor shifts from a first state to a second state in response to said first process command, and
wherein said first semiconductor processor shifted in the second state performs a control of erasing all of information stored in said first nonvolatile memory in response to said second process command.

15. The nonvolatile memory device according to claim 14,
wherein said second command includes a first process command, a third process command, and a fourth process command,
wherein said first semiconductor processor shifted in the second state shifts from the second state to a third state when a result of the third process command is a first result and shifts from the second state to a first state when a result of the third process command is a second result, and
wherein said first semiconductor processor shifted in the third state performs a control of erasing all of information stored in said second nonvolatile memory in response to the fourth process command.

16. The nonvolatile memory device according to claim 15, wherein said second semiconductor processor is a semiconductor processor for an IC card.

17. A nonvolatile memory device comprising:
a first semiconductor processor; and
a first nonvolatile memory,
wherein said first semiconductor processor has a first controller for performing a control of accessing said first nonvolatile memory, a second nonvolatile memory, and a second controller for performing a control of accessing said second nonvolatile memory, and is formed on one first semiconductor substrate,
wherein a plurality of commands are input from the outside to said first semiconductor processor,
wherein said first controller performs a control of erasing information stored in said first nonvolatile memory in response to input of a first command, and
wherein said second controller performs a control of erasing information stored in said second nonvolatile memory in response to input of a second command.

18. The nonvolatile memory device according to claim 17,
wherein each of said first and second nonvolatile memories has a plurality of nonvolatile memory cells,
wherein each nonvolatile memory cell has a threshold voltage and is controlled so that the threshold voltage lies in one of a plurality of threshold voltage distributions,
wherein one threshold voltage distribution indicates an erase state, another threshold voltage distribution indicates a write state, and
wherein said erasing control is performed so that the threshold voltage of said nonvolatile memory cell lies in the threshold voltage distribution indicative of the erase state.

19. The nonvolatile memory device according to claim 18, wherein said first controller performs a control of erasing all of information stored in said first nonvolatile memory in response to input of said first command.

20. The nonvolatile memory device according to claim 18, wherein said second controller performs a control of erasing all of information stored in said second nonvolatile memory and a control of erasing information stored in a part of said first nonvolatile memory in response to input of said second command.

21. The nonvolatile memory device according to claim 18, wherein said second controller performs a control of erasing information stored in a part of said second nonvolatile memory and a control of erasing information stored in a part of said first nonvolatile memory in response to input of said second command.
